(19) United States
(12) Patent Application Publication
(10) Pub. No.: US 2024/0107099 A1
(43) Pub. Date: Mar. 28, 2024

(54) System and Method for Creating Personalized Media Channels

(71) Applicant: SeaChange International Inc., Boston, MA (US)

(72) Inventors: Michal Warenica, Warsaw (PL); Christoph Klimmer, Hamburg (DE)

(21) Appl. No.: 18/473,602

(22) Filed: Sep. 25, 2023

Related U.S. Application Data
(60) Provisional application No. 63/377,076, filed on Sep. 26, 2022.

(51) Int. Cl. H04N 21/2668; H04N 21/254; H04N 21/475; H04N 21/81

(52) U.S. Cl. CPC H04N 21/2668; H04N 21/2541; H04N 21/4756; H04N 21/812

(57) ABSTRACT

A system for a creating personalized media channel includes a content processor, a personalization engine, a scheduler, a data store, and a manifest manipulator. The content processor receives content assets from a content provider, converts each media asset into a respective pre-processed content asset, and extracts content metadata from each media asset. The personalization engine receives as inputs user data and the media metadata and outputs content recommendations. The scheduler receives as an input the content recommendations and outputs a personalized schedule of content, the personalized schedule including one or more of the content recommendations. The data store receives as an input pre-processed content assets from the content importer and outputs content manifests of available content. The manifest manipulator receives as inputs the personalized schedule and the content manifests and outputs a personalized linear manifest based on the personalized schedule of content.

### CROSS-REFERENCE TO RELATED APPLICATIONS

This application claims priority to U.S. Provisional Application No. 63/377,076, titled “System and Method for Linear Channel Creation and Distribution,” filed on Sep. 26, 2022, which is hereby incorporated by reference.

### TECHNICAL FIELD

This application relates generally to media streaming.

### BACKGROUND

Free ad-supported streaming TV (FAST) is growing rapidly. Considering the FAST business model, the operating costs are crucial to run a sustainable business. It would be desirable to minimize and/or optimize the operating costs while providing the ability to create multiple FAST channels without a significant cost increase.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a system for a creating a personalized media channel. The system comprises a content processor configured to receive content assets from a content provider, convert each media asset into a respective pre-processed content asset, and extract content metadata from each media asset; a personalization engine that receives as inputs user data and the media metadata and that outputs content recommendations; a scheduler that receives as an input the content recommendations and that outputs a personalized schedule of content, the personalized schedule including one or more of the content recommendations; a data store that receives as an input pre-processed content assets from the content importer and that outputs content manifests of available content; and a manifest manipulator that receives as inputs the personalized schedule and the content manifests and that outputs a personalized linear manifest based on the personalized schedule of content.

In one or more embodiments, the personalized schedule includes personalized advertisement slots. In one or more embodiments, the personalization engine determines, based on the user data, a total number of the personalized advertisement slots, a length of each personalized advertisement slot and/or a timing of the personalized advertisement slots. In one or more embodiments, the personalized schedule includes targeted advertisement slots for a user group that includes the user.

In one or more embodiments, the personalization engine determines, based on user-group data, a total number of the targeted advertisement slots, a length of each targeted advertisement slot, and/or a timing of the targeted advertisement slots. In one or more embodiments, the content recommendations include personalized content recommendations and/or targeted content recommendations, the targeted content recommendations for the user group, and the personalized schedule includes one or more blocks of targeted content and/or one or more blocks of personalized content, the block(s) of targeted content including at least some of the targeted content recommendations, the block(s) of personalized content including at least some of the personalized content recommendations.

In one or more embodiments, the manifest manipulator is a channel manifest manipulator, and the system further comprises an advertisement manifest manipulator that is configured to insert personalized advertisements into the personalized advertisement slots. In one or more embodiments, a content delivery network is configured to insert personalized advertisements into the personalized advertisement slots. In one or more embodiments, the manifest manipulator is configured to insert personalized advertisements into the personalized advertisement slots.

In one or more embodiments, the content processor is configured to encrypt at least some of the respective pre-processed content assets using respective asset encryption keys to form encrypted pre-processed content assets, and the system further comprises an encryption key management system configured to store the respective asset encryption keys; and a re-encryption service configured to receive a request for a first encrypted pre-processed content asset, and in response to the request, decrypt the first encrypted pre-processed content asset using a corresponding asset encryption key to form a first unencrypted pre-processed content asset and then re-encrypt the first unencrypted pre-processed content asset using a channel encryption key for the personalized media channel.

In one or more embodiments, the system further comprises a digital rights management (DRM) engine configured to pre-provision DRM licenses to a client application prior to and/or during a streaming of the personalized media channel, the DRM licenses for the media assets to be streamed in the personalized media channel.

Another aspect of the invention is directed to a method for creating a personalized media channel. The method comprises in a content processor, pre-processing content assets to form respective pre-processed content assets and extracting content metadata from each media asset; in a personalization engine, producing personalized content recommendations using personal user data of a target user and the content metadata; in a scheduler, creating a personalized channel schedule for the personalized media channel, the personalized channel schedule including at least some of the personalized content recommendations; in a manifest manipulator, creating a linear manifest according to the personalized channel schedule; and producing a media stream for the personalized media channel according to the linear manifest.

In one or more embodiments, the method further comprises receiving, in the personalization engine, real-time personal user data of the target user; updating, with the personalization engine, the personalized content recommendations to include real-time personalized content recommendations; creating, with the scheduler, an updated personalized channel schedule to include at least some of the real-time personalized content recommendations; creating, with the manifest manipulator, an updated linear manifest according to the updated personalized channel schedule; and producing the media stream according to the updated linear manifest. In one or more embodiments, the real-time personal user data includes a rating of a streaming content asset that is currently streaming in the media stream.

In one or more embodiments, the method further comprises producing, with the personalization engine, personalized advertisement slots using the personal user data; and inserting, with the scheduler, the personalized advertisement slots in the personalized channel schedule. In one or more embodiments, a total number of the personalized advertisement slots, a length of each personalized advertisement slot and/or a timing of the personalized advertisement slots is/are personalized using the personal user data. In one or more embodiments, the personalized channel schedule is created using a template that includes one or more blocks of targeted content and/or one or more blocks of personalized content and/or one or more blocks of general-interest content.

In one or more embodiments, the method further comprises encrypting, with the content processor, at least some of the respective pre-processed content assets using respective asset encryption keys to form encrypted pre-processed content assets; and storing the respective asset encryption keys in an encryption key management system. The method further comprises, in a re-encryption proxy, receiving a request for a first encrypted pre-processed content asset to stream on the personalized media channel; obtaining a corresponding asset encryption key for the first encrypted pre-processed content asset from the encryption key management system; and in response to the request, decrypting the first encrypted pre-processed content asset using a corresponding asset encryption key to form a first unencrypted pre-processed content asset and then re-encrypting the first unencrypted pre-processed content asset using a channel encryption key for the personalized media channel.

In one or more embodiments, the method further comprises pre-provisioning, with a digital rights management (DRM) engine, DRM licenses to a client application prior to and/or during a streaming of the personalized media channel, the DRM licenses for at least some of the media assets to be included in the media stream.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a block diagram of a system for creating personalized media channels according to an embodiment.

FIG. 2 illustrates an example structure for a personalized channel.

FIGS. 3A and 3B illustrate example personalized schedules for respective personalized channels.

FIG. 4 is a block diagram of a system for creating personalized media channels according to another embodiment.

FIG. 5 is a flow chart of a method for content onboarding according to an

embodiment.

FIG. 6 is a flow chart of a method for creating a static personalized schedule according to an embodiment.

FIG. 7 is a flow chart of a 70 for providing real-time personalized content according to an embodiment.

FIG. 8 is a block diagram that illustrates a system for decrypting and re-encrypting media on the fly as the media are streamed on the personalized channel according to an embodiment.

FIG. 9 is a flow diagram that further illustrates the operation of the system illustrated in FIG. 8.

FIG. 10 is a block diagram of a system for creating personalized media channels according to another embodiment.

FIG. 11 is a block diagram of a system for creating personalized media channels according to another embodiment.

FIG. 12 is a block diagram of a system for creating personalized media channels according to another embodiment.

FIG. 13 is a flow chart of a method for creating a personalized media channel according to an embodiment.

### DETAILED DESCRIPTION

Personalized media channels are created quickly and at low cost. A content importer receives and pre-processes content files from one or more content sources. A personalization engine produces personalized content recommendations using personal user data and metadata for the pre-processed content files. A scheduler creates a personalized schedule for each user using the personalized content recommendations. The personalized schedule can also include targeted content (e.g., using targeted content recommendations from the personalization engine) and/or general-interest content that can be selected from a curated list. A channel manifest manipulator creates a linear manifest for each personalized channel using the respective personalized schedule. The linear manifest is then used to produce the streaming media for the respective personalized channel. The linear manifest can be updated or formed, at least in part, in real time based on real-time user feedback data.

The manifest manipulator can insert advertisement placeholders into each linear manifest. The placement, duration, and/or frequency of the advertisement placeholders can be personalized for each end-user. The advertisements can be inserted by the channel manifest manipulator, by an advertisement manifest manipulator, or by the content delivery network.

By pre-processing the content files, personalized media channels can be created quickly and inexpensively by creating respective linear manifests.

Technical advantages include, but are not limited to, increasing the output (e.g., personalized media channels) while minimizing any increase in storage space needed to store the media files and linear manifests to form the personalized media channel streams. Only an incremental increase in storage space is needed to store the linear manifest for each personalized media channel created. The media files need to be processed once and stored regardless of the number of channels they are used in. The pre-processed media files do not need to be processed upon channel creation or playback with the exception of any on-the-fly re-encryption.

Another technical advantage is that digital rights management (DRM) license requests can be optimized by pre-provisioning of DRM keys and/or re-encrypting the content on the fly.

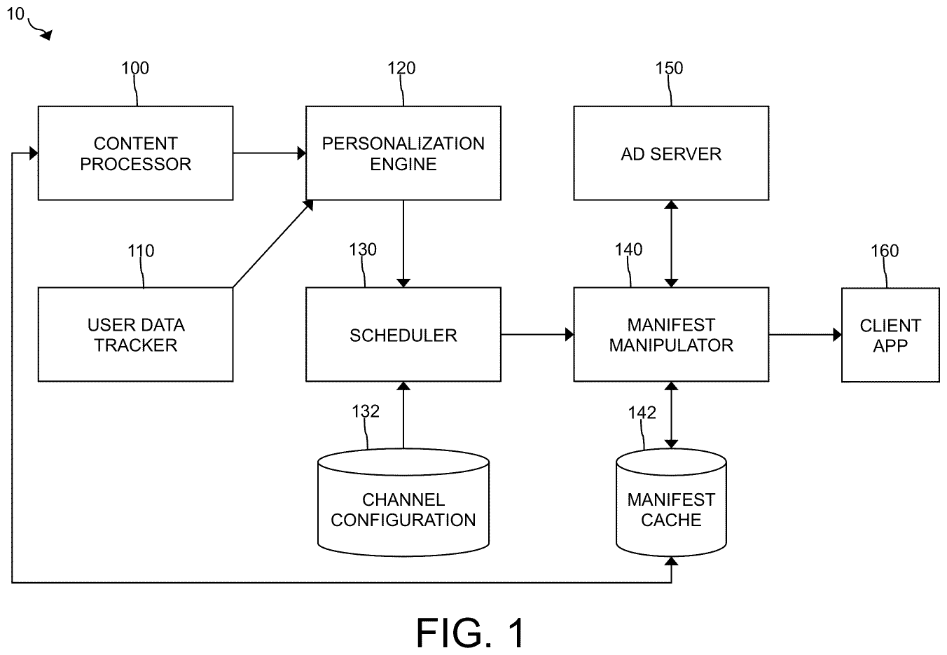

FIG. 1 is a block diagram of a system 10 for creating personalized media channels according to an embodiment. The system 10 includes a content processor 100, a user data tracker 110, a personalization engine 120, a scheduler 130, a manifest manipulator 140, and an advertisement server 150.

The content processor 100 is configured to receive content assets from a content provider and to pre-process the content assets for later use. The content assets include video, audio, subtitles, images, metadata, and/or other content items. Pre-processing the content assets can include transcoding the content assets, such as to a common format, defining different bitrate profiles of each content asset, scaling and/or converting images, unifying metadata for the content assets, converting subtitles to a common format, encrypting, and/or other pre-processing. The pre-processed content assets have a common format and properties to allow the pre-processed content assets to be used interchangeably and without additional processing when creating personalized content channels.

The user data tracker 110 is configured to obtain and gather user data for the end-users/customers of the system 10. The user data can be gathered from each user's profile (e.g., content preferences), account information, viewing history, content reviews, social media accounts, and/or other sources. The user data can include personal user data that is specific to the user (e.g., viewing history, social media posts). In addition, the user data can include demographic user data (e.g., age, gender, location). The user data tracker 110 can receive real-time viewing data, directly or indirectly, from the client application 160. The real-time viewing data can include the user's ratings of the content currently and/or recently consumed.

The personalization engine 120 has inputs that are coupled to the outputs of the content processor 100 and the user data tracker 110. The inputs to the personalization engine 120 include content metadata from the content processor 100 and user data from the user data tracker 110. The personalization engine 120 is configured to produce personalized content recommendations for each user. The personalization engine 120 can include a recommendation engine that can produce content recommendations based on each user's viewing history, content reviews, social media accounts, and/or other personal user data. For example, the recommendation engine can recommend a movie with one or more common actors and/or directors that were in a movie that a user rated highly. In another example, the recommendation engine can recommend a movie that a friend recently watched according to social media posts. In another example, the recommendation engine can recommend one or more comedy movies if the user indicated in her content preferences that she likes comedies.

The recommendation engine can also produce targeted content recommendations based on target viewer data such as demographic data. For example, the recommendation agent can recommend shows based on the user's age group, gender, and/or location.

In some embodiments, the recommendation engine can recommend personalized advertisement slots. The length of each advertisement slot can be set (e.g., customized and/or personalized) individually for the user. For example, the viewing history of one user may indicate that he typically changes the channel or stops watching when more than 2 minutes of advertisements are played consecutively. For that user, the advertisement slots can be set to 1 minute or 1.5 minutes.

In addition or in the alternative, the total number of advertisement slots within a predetermined time period can be set (e.g., customized and/or personalized) individually for the user. The predetermined time period can be a half hour, an hour, a day, the length of a program, or another time period. In addition or in the alternative, the total length of the advertisement slots within a predetermined time period can be set (e.g., customized and/or personalized) individually for the user. In addition or in the alternative, the absolute or relative timing of the advertisement slots in the personalized channel can be customized/personalized.

In some embodiments, the recommendation engine can recommend targeted advertisement slots. The length of each advertisement slot, the total number of advertisement slots within a predetermined time period, the total length of the advertisement slots within a predetermined time period, and/or the absolute and/or relative timing of the targeted advertisement slots can be based on target viewer data such as demographic data and one or more rules, settings, and/or configurations.

The personalization engine 120 can use artificial intelligence, neural networks, algorithms, and/or other computerized methods to produce the content recommendations, the personalized advertisement slots, and/or the targeted advertisement slots.

The content recommendations and the optional personalized advertisement slots are provided as inputs to the scheduler 130. The scheduler 130 is configured to produce a personalized schedule for each user. The personalized schedule can include time blocks that are created differently. For example, the personalized schedule includes one or more time blocks of personalized content. In addition, the personalized schedule can include one or more time blocks of targeted content and/or one or more time blocks of general-interest content. The number of each type of time block and the arrangement of time blocks can be set according to channel configuration settings 132. The personalized schedule can also include some or all of the personalized/customized advertisement time slots from the personalization engine 120.

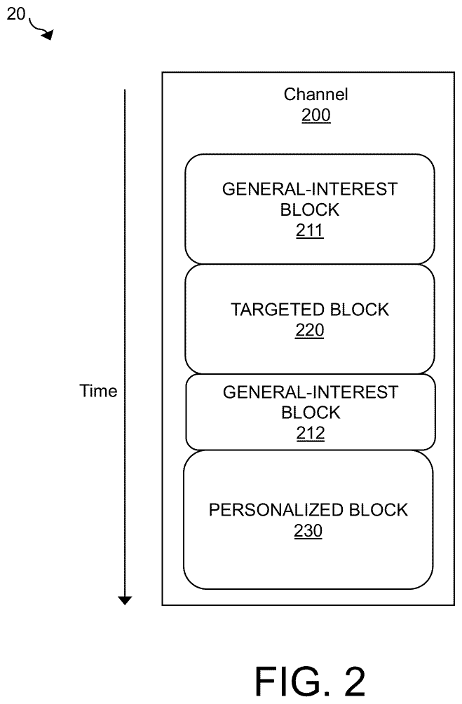

An example of a structure 20 for a personalized channel 200 is illustrated in FIG. 2. The structure 20 can be stored in the channel configuration settings 132 and/or can be created on the fly by the scheduler 130. The structure 20 includes general-interest time blocks 211, 212, a targeted time block 220, and a personalized time block 230. The structure 20 can alternatively be referred to as a template.

The scheduler 130 can fill the general-interest time blocks 211, 212 with content selected from a library of curated content. The content can be selected using one or rules, settings, and/or configurations from the channel configuration settings 132. For example, the curated content can be selected based on the time of day, relative popularity, ratings, and/or other criteria. Alternatively, the general-interest content can be pre-selected.

The scheduler 130 can fill the targeted time block 220 using the targeted content recommendations from the personalization engine 120. The content from the targeted content recommendations can be selected using one or rules, settings, and/or configurations from the channel configuration settings 132. For example, the content from the targeted content recommendations can be selected based on the time of day, relative popularity, ratings, and/or other criteria.

The scheduler 130 can fill the personalized time block 230 using the personalized content recommendations from the personalization engine 120. The content from the personalized content recommendations can be selected using one or rules, settings, and/or configurations from the channel configuration settings 132. For example, the content from the personalized content recommendations can be selected based on the time of day, relative popularity, ratings, and/or other criteria.

The system 10 can be implemented as software (e.g., computer-readable instructions executed by one or more processors) and/or hardware (e.g., processors and/or graphics processing units with associated computer memory).

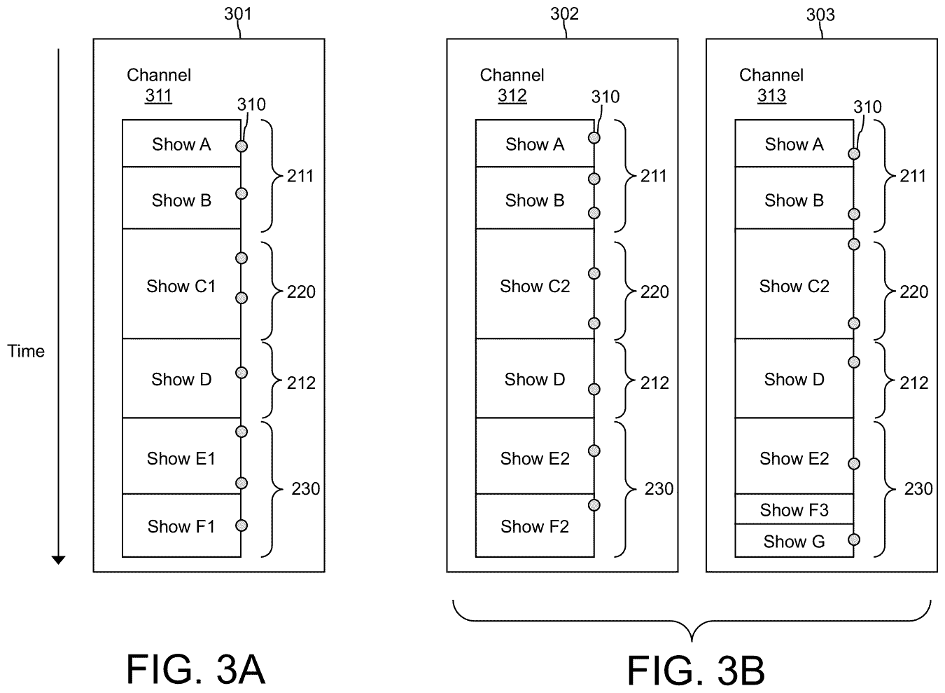

FIGS. 3A and 3B illustrate personalized schedules 301-303 for personalized channels 311-313. The personalized schedules 301-303 are created using the structure 20 (FIG. 2) for different users. The first personalized schedule 301 is for a first user. The second personalized schedule 302 is for a second user. The third personalized schedule 303 is for a third user.

All personalized schedules 301-303 have the same general-interest content in general-interest time blocks 211, 212. The second and third users are members of the same target/demographic group, and thus both the respective second and third personalized schedules 302, 303 include Show C2 in targeted time block 220. The content in the personalized time block 230 is different in each personalized schedule 301-303. Personalized schedules 302 and 303 both include Show E2 due to an overlap in personal user data of the respective users. The personalized schedules 301-303 can optionally include personalized advertisement slots 310.

Returning to FIG. 1, the manifest manipulator 140 receives the personalized schedule and the optional personalized advertisement slots from the scheduler 130. The manifest manipulator 140 is configured to create a linear manifest of content according to the personalized schedule. The manifest manipulator 140 is coupled to a manifest cache or data store 142 that includes some or all of the manifests of pre-processed content assets. To the extent that only some of the manifests of pre-processed content assets are stored in the manifest cache 142, the manifest cache 142 can request additional manifests from the content processor 100 as needed. Each manifest includes one or more files that describes or lists the content segments or chunks needed to play a particular show or content. The manifest manipulator 140 creates a manifest of the personalized channel using the information from the manifests of pre-processed content assets. The information on content chunks is arranged according to the personalized schedule.

The manifest manipulator 140 can insert placeholders (e.g., SCTE35 markers) for advertisement slots, including any personalized advertisement slots, which can be filled by the manifest manipulator 140 (or another manifest manipulator) with advertisements from the advertisement server 150. The personalized advertisement slots can be filled when the linear manifest is created or at a later time (e.g., closer to the time of viewing).

The linear manifest is sent from the manifest manipulator 140 to a client application 160 to allow the user to stream the personalized channel. The client application 160 can be run on a smartphone, a laptop, a desktop, a tablet, a smart television, a set-top box (STB), and/or another computing device. The client application 160, via the computing device, can be in communication with a video/media server, such as in a content delivery network, to stream the personalized channel according to and/or using the linear manifest.

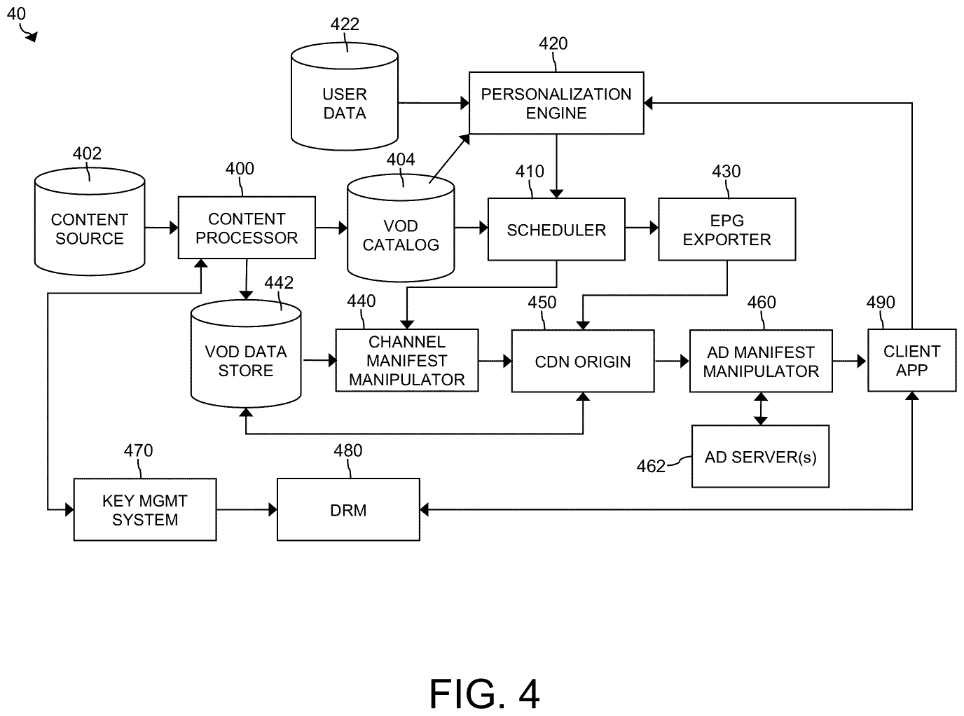

FIG. 4 is a block diagram of a system 40 for creating personalized media channels according to another embodiment. The system 40 includes a content processor 400, a scheduler 410, a personalization engine 420, an electronic program guide (EPG) exporter 430, a channel manifest manipulator 440, a content delivery network (CDN) origin 450, an advertisement manifest manipulator 460, a key management system 470, and a digital rights management (DRM) engine 480.

The content processor 400 is configured to receive content assets from one or more content providers/sources 402 and to pre-process the content assets for later use. The content processor 400 can be the same as content processor 100 (FIG. 1).

The output of the content processor 400 is a catalog or library 404 of on-demand content (e.g., video and/or audio content). The catalog/library 404 can include a text list of the on-demand content. The catalog/library 404 can also include metadata regarding the on-demand content. The metadata can include the type of content (e.g., video or audio), the length, the actors, the directors, the producers, the genre of content (e.g., drama, comedy, etc.), the year of release, studio, language(s), any target age range(s), any target gender(s), description in long/medium/short form keywords, images, and/or other metadata. The catalog/library 404 can be stored on the content processor 400, the scheduler 410, and/or a server.

The scheduler 410 can access the catalog/library 404 to search for and select content when creating a personalized schedule of on-demand content for a personalized channel for a given user. The scheduler 410 can create the schedule using one or more rules, settings, and/or configurations such as in channel configuration settings 132 (FIG. 1). In some embodiments, the scheduler 410 can use a structure/template 20 (FIG. 2) with different types of time blocks to create the personalized schedule. The scheduler 410 can create some or all of the personalized schedule using one or more inputs received from the personalization engine 420. The personalized schedule can include personalized/customized advertisement time slots which can be provided as one or more inputs from the personalization engine 120. The scheduler 410 can be the same as the scheduler 130 (FIG. 1).

The personalization engine 420 is configured to produce personalized content recommendations that can be included in the personalized schedule created by the scheduler 410. For example, the personalization engine 420 can include a recommendation engine that can produce personalized content recommendations based on personal user data 422 such as the user's viewing history, content reviews, social media accounts, and/or other personal user data. The recommendation engine can also produce targeted content recommendations based on target user data 422 such as demographic data. For example, the recommendation agent can recommend shows based on the user's age group, gender, and/or location. In some embodiments, the recommendation engine can recommend personalized/customized advertisement slots (e.g., as discussed herein).

The personalization engine 420 can use artificial intelligence, neural networks, algorithms, and/or other computerized methods to produce the content recommendations and the personalized advertisement slots. The personalization engine can be the same as the personalization engine 120.

The personalization engine 420 can access and/or query the VOD catalog 404 to create the content recommendations. In some embodiments, the personalization engine 420 can make personalized content recommendations, including real-time personalized content recommendations, based on real-time feedback data from the client application 490 on which the user is viewing the personalized channel. The real-time feedback data can include the user's ratings of current programming and/or any user actions (e.g., changing the channel, turning off the client application, etc.).

The EPG exporter 430 receives from the scheduler 410 the personalized schedule and optionally the metadata for the content in the personalized schedule. The EPG exporter 430 is configured to produce an EPG for the personalized channel using the personalized schedule and optional metadata.

The channel manifest manipulator 440 receives the personalized schedule and the optional personalized advertisement slots from the scheduler 410. The channel manifest manipulator 440 is configured to create a linear manifest of content according to the personalized schedule. The channel manifest manipulator 440 is coupled to a VOD data store 442 that includes manifests of the content available in the VOD catalog 404. The channel manifest manipulator 440 creates a manifest of the personalized channel using the information from the manifests of pre-processed content assets (e.g., stored in VOD data store 442). The information on content chunks is arranged according to the personalized schedule. The channel manifest manipulator 440 can insert placeholders (e.g., SCTE35 markers) for advertisement slots including any personalized advertisement slots. Each placeholder can indicate or define the length of the respective advertisement slot. The channel manifest manipulator 440 can be the same as the manifest manipulator 140.

The CDN origin 450 receives the linear manifest from the channel manifest manipulator 440 and the EPG from the EPG exporter 430. The CDN origin 450 includes one or more content servers that is/are configured to stream the media for the personalized channel. The media is streamed according to the linear manifest which identifies the media files (e.g., content chunks) and order of media files to create the personalized channel. The CDN origin 450 can retrieve the media files from the VOD data store 442. The media stream includes the advertisement placeholders (e.g., SCTE35 markers).

The advertisement manifest manipulator 460 is configured to replace the advertisement placeholders with advertisements to play on the personalized channel. The advertisement manifest manipulator 460 is in communication with one or more advertisement servers 462 to retrieve the advertisements (e.g., advertisement media files and associated metadata).

The streamed content can include media that are copyright protected and/or that may need to be encrypted such as with a digital-rights management system. For example, protected content can be identified in the metadata from the content source 402. The protected content can be encrypted by the content processor 400 using one or more encryption keys that can be sent to and/or provided by the key management system 470.

At playback, the DRM engine 480 can decrypt each encrypted media file and then re-encrypt that media file (e.g., on the fly) using an encryption key for the personalized channel. The encryption key for the personalized channel is also provided to the client application 490 to decrypt the personalized channel for consumption (e.g., viewing and/or listening).

Alternatively, the DRM engine 480 can pre-provision the appropriate DRM licenses, including the encryption keys, for the encrypted media files to the client application 490 prior to and/or during streaming/viewing of the personalized channel. Providing the DRM licenses in advance of when they are needed to view DRM-protected content can reduce network traffic and congestion. For example, if a large number of viewers is streaming the same DRM-protected content simultaneously (e.g., in a common channel or in respective personalized channels), there would be a large spike in network traffic for DRM license requests when DRM-protected content streaming begins. Providing the DRM license(s) to some or all of the viewers (e.g., via their respective client applications) in advance can reduce and/or eliminate network traffic spikes. The DRM licenses can be pre-provisioned in batches. The batches can represent a portion or subset of the total number of DRM licenses needed to view the personalized channel for a given time period. The number of DRM licenses that can be pre-provisioned may be limited for personalized content that is selected/determined in real time.

The system 40 can be implemented as software (e.g., computer-readable instructions executed by one or more processors) and/or hardware (e.g., processors and/or graphics processing units with associated computer memory).

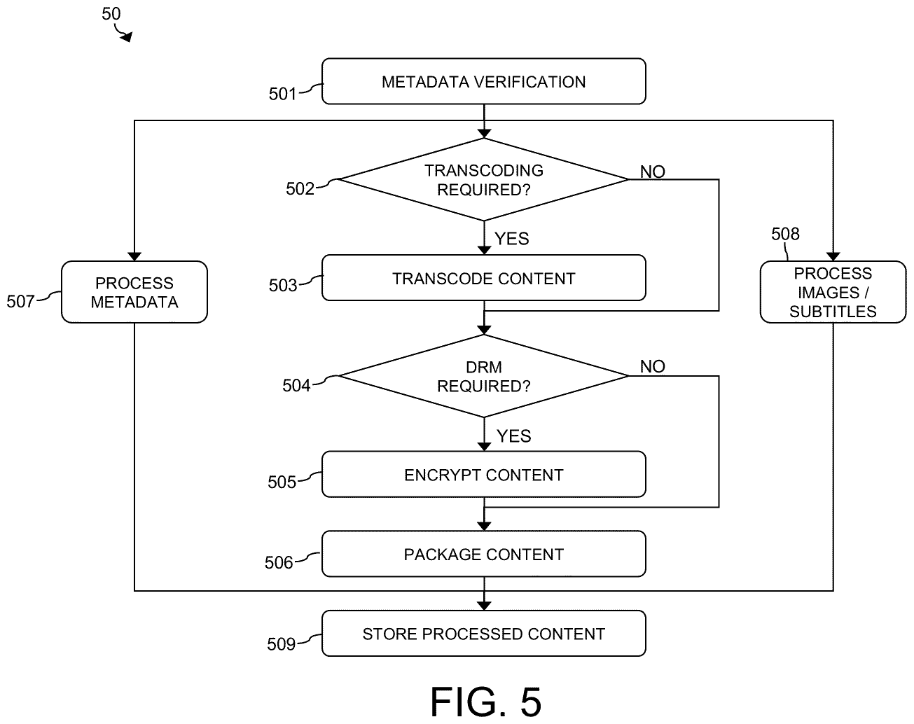

FIG. 5 is a flow chart of a method 50 for content onboarding according to an embodiment. Method 50 can be performed the content processor 400.

In step 501, the metadata of the onboarded content (e.g., retrieved from content source 402) is verified and unified. The verification/validation can ensure that at least a unique content identifier is included in the metadata. The metadata can optionally be used to create an EPG representing the personalized channel.

In step 502, it is determined whether transcoding of the onboarded content is needed. Transcoding is needed when the onboarded content does not match the output specification, which can be defined in the platform configuration. Transcoding is not needed when the onboarded content matches the output specification. If transcoding is needed, the onboarded content is transcoded in step 503. If not, step 503 is bypassed. Transcoding can include converting the format of the onboarded content into a uniform format for the personalized channel. Transcoding can also include creating different encoding profiles covering different bitrates, resolutions, and/or codecs. Multiple codecs can be used to accommodate a broader set of devices on which the client application runs. Transcoding can also include dividing the onboarded content into chunks or segments.

In step 504, it is determined whether the onboarded media is subject to copyright protection and/or whether DRM is required. If so, the onboarded content is encrypted in step 505. If not, step 505 is bypassed. The onboarded content can be encrypted with an encryption key that can be provided by the key management system 470 (FIG. 4). To the extent the onboarded content is divided into chunks/segments in step 503, each chunk/segment can be encrypted using the same encryption key or a different encryption key.

In step 506, the onboarded content is packaged. Packaging can include wrapping the content in a container. For example, the container can include a manifest that describes all elements of the content and that allows the content to be played back on an end device. Packaging can occur according to one or more protocols. Examples of protocols for over-the-top (OTT) (e.g., over the Internet) video content include Dynamic Adaptive Streaming over HTTP (DASH) and HTTP Live Streaming (HLS).

In step 507, following step 501, the metadata is processed. Metadata processing can include converting the metadata into a common format.

In step 508, following step 501, any images and/or subtitles are processed. Image/subtitle processing can include converting the images/subtitles into a common format.

In step 509, following steps 506-508, the processed content is stored.

Steps 501-509 can be repeated for each content/asset that is onboarded.

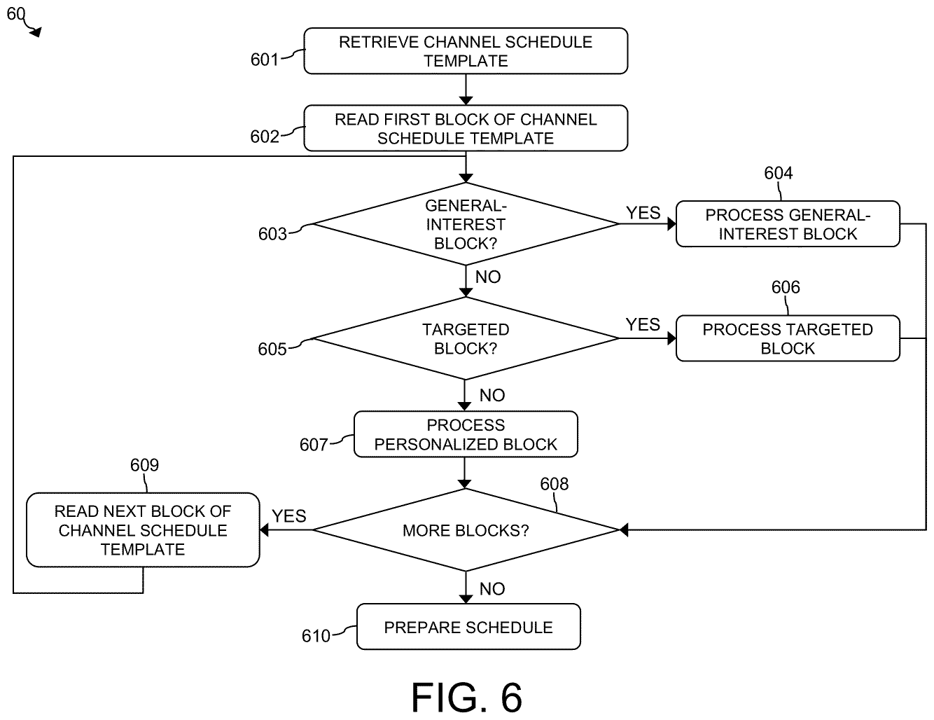

FIG. 6 is a flow chart of a method 60 for creating a static personalized schedule according to an embodiment. Method 60 can be performed by the scheduler 130, 410.

In step 601, the scheduler retrieves a channel schedule template which includes multiple types of blocks of content. Each content block represents a period of time and an interest type of content. The interest type can be general-interest, targeted, personalized, or another interest type. The channel schedule template can be the same as the example structure/template 20 (FIG. 2). The channel schedule template can be stored in the scheduler and/or in channel configuration settings (e.g., channel configuration settings 132 (FIG. 1)).

Each content block is processed to create a block schedule with particular media assets based on the media asset lists available to the scheduler and to set the timeline for each media asset. The media asset lists are different according to the type of content block. For example, the schedule for a personalized block is created with media assets selected from a personalized media asset list. Likewise, the schedule for a targeted block is created with media assets selected from a targeted media asset list. The schedule for a general-interest block is created with media assets selected from a general-interest media asset list.

The schedule for each content block can include the placement of any advertisements, which can be made in general-interest (e.g., fixed), targeted, or customized/personalized advertisement slots.

Content block processing results in the schedule for a particular channel including lists of media assets and start times and advertisement slots and start times. In one embodiment, the content blocks are processed upfront such that the schedule for all blocks (e.g., over a predetermined time period such as 12 hours or 24 hours) is determined in advance. An advantage of this embodiment is that the schedule is available to the end user in advance and viewable on an EPG.

In another embodiment, the content blocks are processed dynamically during (or shortly before) streaming. For example, an initial lookahead window of the current content block can be pre-processed to provide a predetermined length of content for the personalized channel. As the initial lookahead window nears completion (e.g., at about 90% completion to about 95% completion), a second lookahead window of the current content block can be pre-processed to provide a second predetermined length of content for the personalized channel. The content in the second lookahead window can be selected dynamically based on end-user feedback data (e.g., ratings, social media posts, etc.) regarding the content in the initial lookahead window, feedback data regarding friends of the end user, real-world events, and/or other data that can be provided in real time. An advantage of this embodiment is that the schedule can be created dynamically to enhance the personalization/customization (or targeting in the case of targeted content) of content on the customized channel.

In step 602, the scheduler reads the first block of the channel schedule template. If interest type of the first block is general-interest content (i.e., step 603=yes), then the first block is processed as general interest in step 604. Processing the first block as general interest includes filling in the first block with general-interest content. The scheduler can have access to a fixed list of general-interest content, which can be handpicked by the operator and/or defined by a set of rules using content metadata to filter the content. The scheduler can select the programs from the list of general-interest content using one or more rules or factors, which can include the day of the week, time of day, popularity of the program, recent and/or real-time news events, and/or other rules/factors.

Processing the first block as general interest in step 604 can also include scheduling advertisement slots/breaks. The advertisement slots/breaks can be scheduled according to one or more rules or factors.

If the interest type of the first block is not general-interest content (i.e., step 603=no), the scheduler determines whether the first block is targeted content in step 605. If interest type of the first block is targeted content (i.e., step 605=yes), then the first block is processed as targeted in step 606. Processing the first block as targeted includes filling in the first block with targeted content. The scheduler can have access to a list of targeted content for each target segment. The lists can be created by the personalization/recommendation engine (e.g., personalization engine 120, 420). Target segments can include age brackets, gender, profession, and/or other target segment. The scheduler can select the programs from the list of targeted content using one or more rules or factors, which can include the day of the week, time of day, popularity of the program, recent and/or real-time news events, and/or other rules/factors.

Processing the first block as targeted interest in step 606 can include scheduling targeted advertisement slots/breaks. The targeted advertisement slots/breaks can be determined and output by the personalization/recommendation engine. The personalization/recommendation engine can configure the length of each targeted advertisement slot, the total number of targeted advertisement slots within a predetermined time period, the total length of the targeted advertisement slots within a predetermined time period, and/or the absolute and/or relative timing of the targeted advertisement slots in the personalized channel. In one embodiment, only the blocks of targeted content include targeted advertisement slots/breaks. In another embodiment, both the targeted-content blocks and some or all of any general-interest content blocks include targeted advertisement slots/breaks.

If the interest type of the first block is not targeted content (i.e., step 605=no), the scheduler can process the first block as personalized in step 607. Alternatively, the scheduler can determine whether the first block is personalized content or another content type before processing the first block as personalized or another content type. Processing the first block as personalized includes filling in the first block with personalized content. The scheduler can fill the personalized time block using a list of personalized content recommendations for the end user from the personalization/recommendation engine (e.g., personalization engine 120, 420). The content from the list of personalized content recommendations can be selected using one or more rules or factors, which can include the day of the week, time of day, popularity of the program, recent and/or real-time news events, and/or other rules/factors.

Processing the first block as personalized interest in step 607 can include scheduling personalized/customized advertisement slots/breaks. The personalized/customized slots/breaks can be determined and output by the personalization/recommendation engine. The personalization/recommendation engine can configure the length of each personalized/customized advertisement slot, the total number of personalized/customized advertisement slots within a predetermined time period, the total length of the personalized/customized advertisement slots within a predetermined time period, and/or the absolute and/or relative timing of the personalized/customized advertisement slots in the personalized channel. In one embodiment, only the blocks of personalized content include personalized/customized advertisement slots/breaks. In another embodiment, the personalized content blocks, some or all of any targeted-content blocks, and some or all of any general-interest content blocks include personalized/customized advertisement slots/breaks.

After the first block is processed in step 604, 606, or 607, the scheduler determines in step 608 if there are any additional blocks in the channel schedule template to process. If so (i.e., step 608=yes), the next block of the channel schedule template is read in step 609. After step 609, the flow chart is repeated starting at step 603. This continues in a loop until all blocks are processed.

After all blocks are processed (i.e., step 608=no), the personalized schedule is prepared in step 610. Preparing the personalized schedule can include combining the information from block processing into the full channel schedule. At this point an arranged list of media assets and advertisement breaks is generated and made available for the manifest manipulator to allow the personalized channel to be played/streamed. The schedule includes start time information describing when the personalized channel starts and whether the schedule should be repeated.

In some embodiments, one or more (e.g., one, some, or all) of the personalized blocks and/or of the targeted blocks are at least partially filled in on the fly (in real time). The initial lookahead window of one or more of these personalized blocks and/or of the targeted blocks can be prepared in step 610.

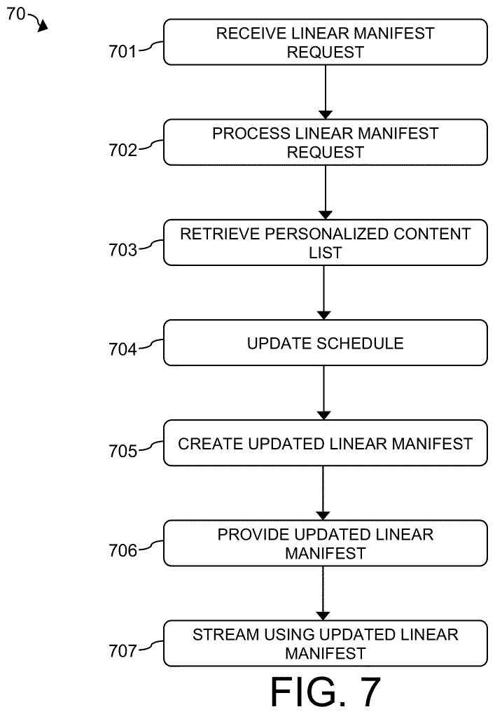

FIG. 7 is a flow chart of a method 70 for providing real-time personalized content according to an embodiment.

In step 701, the channel manifest manipulator receives a request for a linear manifest. This step can occur frequently during playback to allow the linear manifest to be updated with new content and/or new chunks. If the request is made when the personalized schedule is approaching the end of a defined window of content, the request can trigger the channel manifest manipulator to create the next portion of the linear manifest. In response, the channel manifest manipulator may send a request to the scheduler for an updated schedule for the next content window. The request for the linear manifest can be made by the client application or the CDN origin (e.g., CDN origin 450 (FIG. 4)).

In step 702, the request for the linear manifest is processed. Processing the linear manifest request can include sending a request for a schedule (e.g., an updated schedule) to the scheduler.

In step 703, the scheduler retrieves, fetches, and/or receives a personalized content list from the personalization engine. The personalized content list includes personalized content recommendations that can be updated in real time based on user actions and/or in response to current events. Examples of user actions include social media posts, reviews of programming on the personalized channel, and/or the user stopping watching the programming on the client app. Examples of current events include weather events, sports events, news events, and/or other events that may be relevant and/or followed by the user. For example, programming that includes sports events relating to teams that the user follows may be included. Programming that includes weather events, news events, and/or other events relating to the user's home geographic area may also be included.

In step 704, the scheduler updates the schedule for the personalized block with programming from the personalized content list.

In step 705, the channel manifest manipulator creates an updated linear manifest based on the updated scheduled prepared in step 704.

In step 706, the channel manifest manipulator provides the updated linear manifest to the client application or the CDN origin. The client application can use the linear manifest to retrieve the appropriate media files from the CDN origin to stream the media in step 707. The CDN origin can use the linear manifest to manage and/or retrieve content chunks and/or video segments.

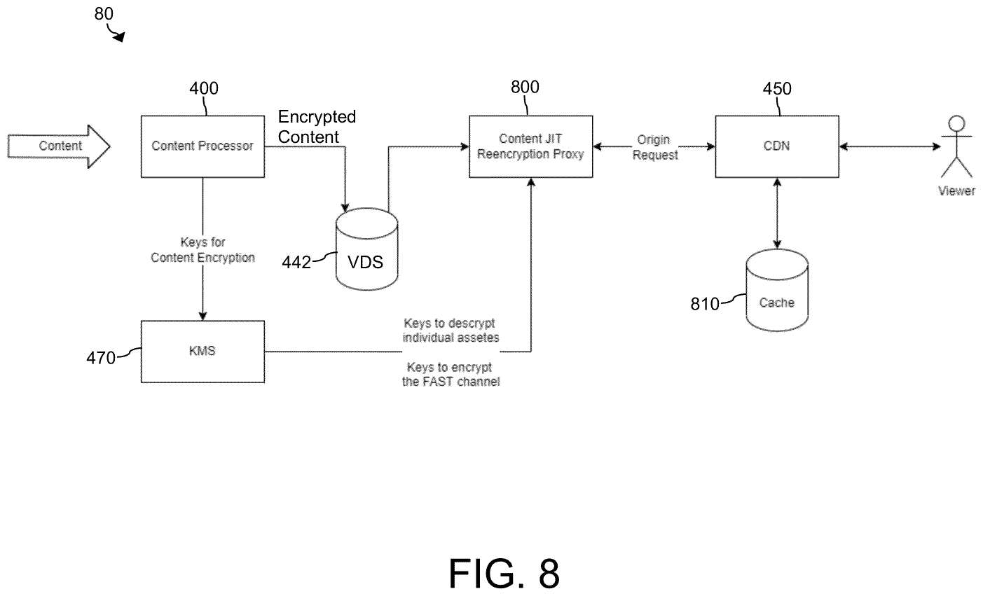

FIG. 8 is a block diagram that illustrates a system 80 for decrypting and re-encrypting media on the fly as the media are streamed on the personalized channel according to an embodiment. The system 80 includes the content processor 400, the VOD data store 442, a re-encryption proxy 800, the CDN origin 450, and the key management system 470.

The content processor 400 processes content received from a content provider (e.g., content source(s) 402 (FIG. 4)), for example as discussed with respect to FIGS. 1, 4, and 5. Processing the content includes transcoding (if needed) and encrypting (e.g., if DRM is required) the content files. The content files can be individually encrypted with respective encryption keys which are provided to and stored by the key management system (KMS) 470. Alternatively, the encryption keys can be provided to content processor 400 by the KMS 470, which can also store the encryption keys. In either case, each encryption key is stored with a mapping of a respective encryption key identifier to the respective encrypted content file that is encrypted using that encryption key. In some embodiments, a single encryption key can be used to encrypt more than one content file and/or multiple chunks/segments of the same content file. The mapping of the encryption key identifiers to the respective encrypted media files can be stored in the KMS 470 or the re-encryption proxy 800.

The encrypted content files are stored in the VOD data store 442. When one or more content files is/are needed for streaming the personalized channel, the CDN origin 450 requests the content file(s) from the re-encryption proxy 800. The CDN origin 450 can temporarily store one or more content files for streaming in a local cache 810.

In response to the request for the content file(s), the re-encryption proxy 800 sends a request to the VOD data store 442 for the encrypted content file(s). In addition, the re-encryption proxy 800 sends a request to the KMS 470 for the encryption key(s) that correspond to the requested encrypted content file(s). In one embodiment, the re-encryption proxy 800 can look up in a table or database the identifier(s) of the encryption key(s) that were used to encrypted the requested encrypted content file(s). In this embodiment, the re-encryption proxy 800 can send a request to the KMS 470 for the encryption key(s) that correspond to the encryption key identifier(s) found in the table/database. In another embodiment, the re-encryption proxy 800 can send a request to the KMS 470 for the encryption key(s) that correspond to the requested encrypted content file(s). In that embodiment, the KMS can look up in a table or database the identifier(s) of the encryption key(s) that were used to encrypted the requested encrypted content file(s) and then provide the encryption key(s) that match the encryption key identifier(s) found in the table/database.

In either case, the KMS 470 also sends an additional channel encryption key to the re-encryption proxy 800. The channel encryption key is an encryption key used to encrypt all content on the personalized channel. The client app 490 (FIG. 4) also has the channel encryption key to decrypt the content stream. Each personalized channel can have a separate/respective channel encryption key (and corresponding channel encryption key identifier).

The KMS 470 uses the individual encryption key(s) to decrypt the respective requested encrypted content file(s). After the requested encrypted content file(s) are decrypted to form unencrypted requested content file(s), the unencrypted requested content file(s) are then re-encrypted using the channel encryption key. The requested content file(s) that are re-encrypted using the channel encryption key can be referred to as requested channel-encrypted content file(s). The requested channel-encrypted content file(s) is/are provided to the CDN origin 450 for streaming and/or temporary storage in cache 810.

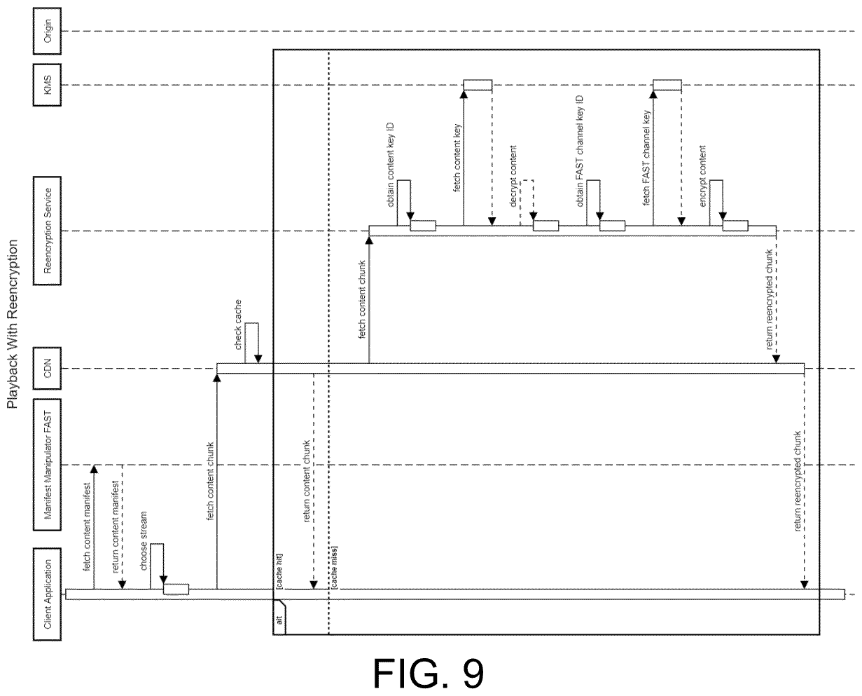

FIG. 9 is a flow diagram that further illustrates the operation of system 80.

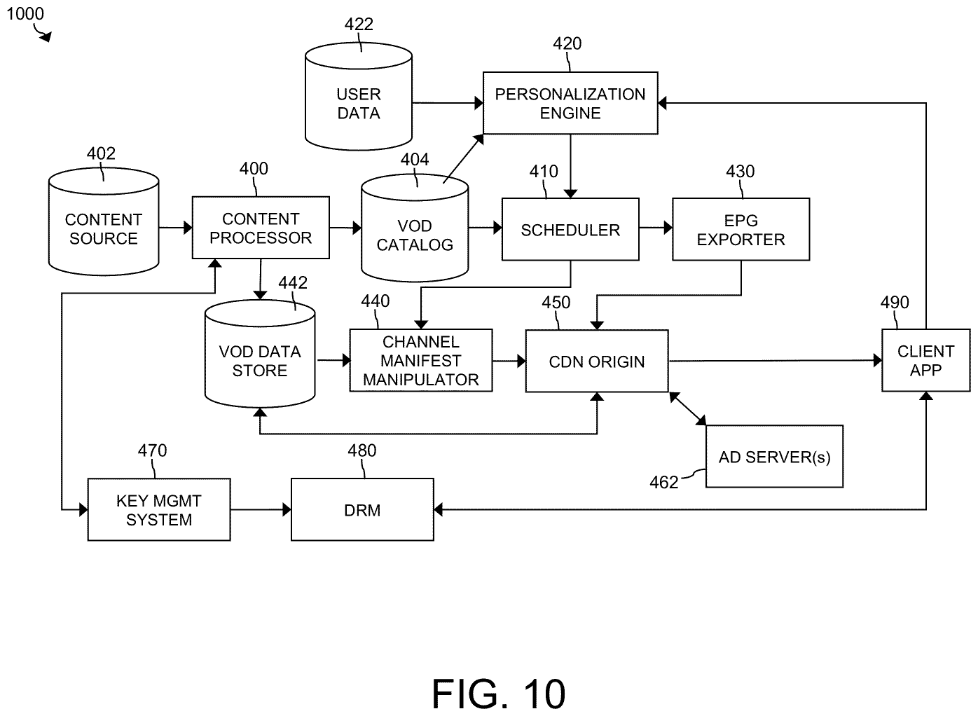

FIG. 10 is a block diagram of a system 1000 for creating personalized media channels according to another embodiment. Systems 400 and 1000 are the same except that system 1000 does not include the advertisement manifest manipulator 460. In system 1000, the CDN origin 450 replaces the advertisement placeholders with the advertisements to play on the personalized channel. The CDN origin 450 is in communication with one or more advertisement servers 462 to retrieve the advertisements (e.g., advertisement media files and associated metadata).

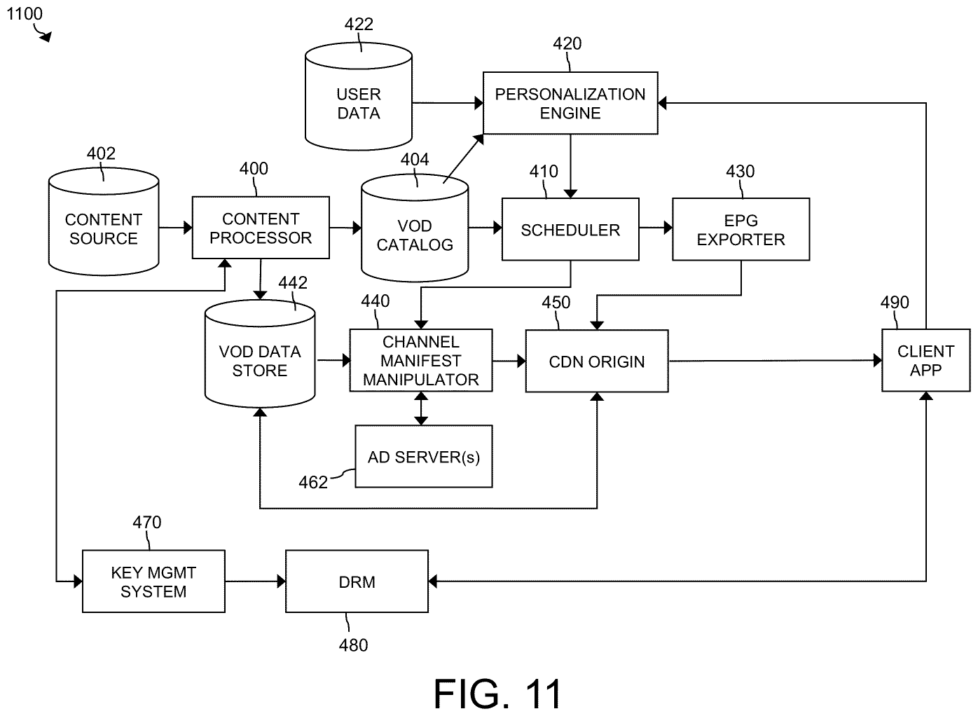

FIG. 11 is a block diagram of a system 1100 for creating personalized media channels according to another embodiment. Systems 400 and 1100 are the same except that system 1100 does not include the advertisement manifest manipulator 460. In system 1100, the channel manifest manipulator 440 replaces the advertisement placeholders with the advertisements to play on the personalized channel. The channel manifest manipulator 440 is in communication with one or more advertisement servers 462 to retrieve the advertisements (e.g., advertisement media files and associated metadata).

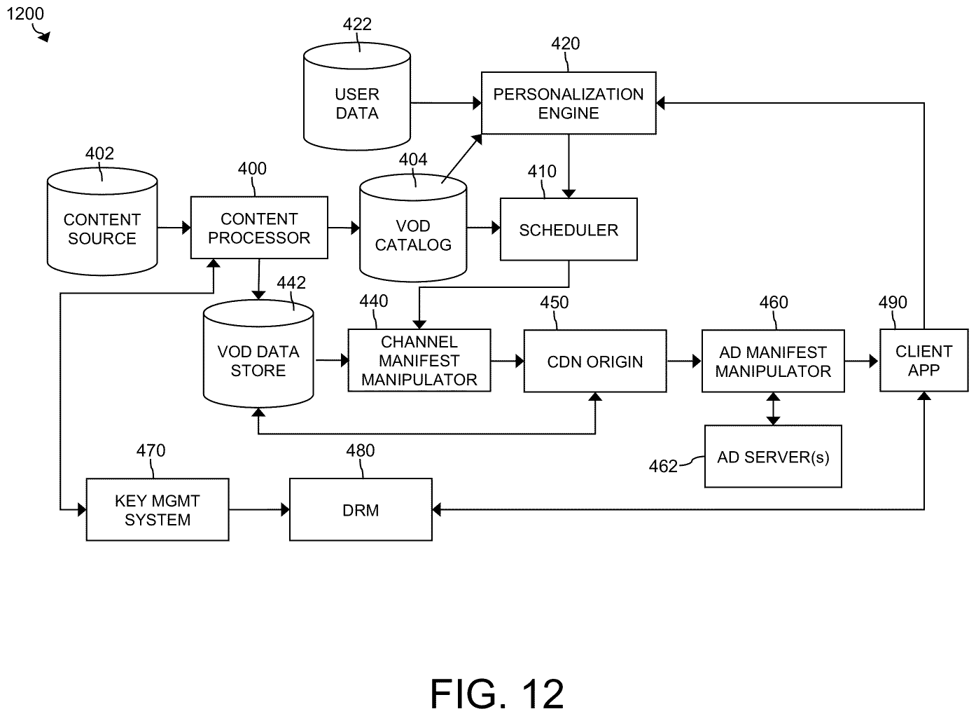

FIG. 12 is a block diagram of a system 1200 for creating personalized media channels according to another embodiment. Systems 400 and 1200 are the same except that that system 1200 does not include the EPG exporter 430. System 1200 can be used for real-time (or just-in-time) scheduling where EPGs are not used because the schedule is not known in advance. For example, system 1200 can be used when the personalized media channel only includes real-time (or just-in-time) scheduled programming.

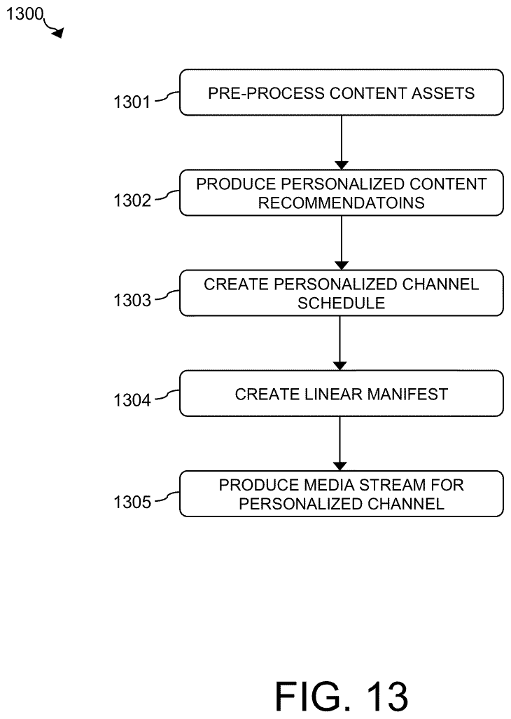

FIG. 13 is a flow chart of a method 1300 for creating a personalized media channel according to an embodiment. Method 1300 can be performed using system 10, 400, 1000, 1100, or 1200.

In step 1301, the content processor pre-processes content/media assets that can be received from one or more content sources (e.g., content servers). Pre-processing can include transcoding the content/media assets. Multiple segments or chunks or some or all of the content/media assets can be created. In addition, metadata can be extracted and/or processed for the content/media assets. In some embodiments, step 1301 can be performed according to method 50.

In step 1302, the personalization engine produces personalized content recommendations for the end-user. The personalized content recommendations can be based on personal user data of the end-user and the content metadata.

In step 1303, the scheduler creates a personalized channel schedule for the personalized media channel. The personalized channel schedule includes at least some of the personalized content recommendations produced in step 1302.

In step 1304, the manifest manipulator creates a linear manifest according to the personalized channel schedule created in step 1303.

In step 1305, a media stream for the personalized media channel is produced according to the linear manifest. The media stream can be produced by the content delivery network (e.g., CDN origin 450).

In some cases, the systems and/or methods are described and/or illustrated with respect to creating a single personalized media channel. However, this is merely for illustration purposes to describe certain embodiments more clearly. It is noted that the systems and/or methods can be used to create multiple personalized media channels for multiple end users/customers. In some cases, the systems and/or methods can create hundreds, thousands, or more personalized media channels.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for a creating a personalized media channel, comprising:
a content processor configured to receive content assets from a content provider, convert each media asset into a respective pre-processed content asset, and extract content metadata from each media asset;
a personalization engine that receives as inputs user data and the media metadata and that outputs content recommendations;
a scheduler that receives as an input the content recommendations and that outputs a personalized schedule of content, the personalized schedule including one or more of the content recommendations;
a data store that receives as an input pre-processed content assets from the content importer and that outputs content manifests of available content; and
a manifest manipulator that receives as inputs the personalized schedule and the content manifests and that outputs a personalized linear manifest based on the personalized schedule of content.

2. The system of claim 1, wherein the personalized schedule includes personalized advertisement slots.

3. The system of claim 2, wherein the personalization engine determines, based on the user data, a total number of the personalized advertisement slots, a length of each personalized advertisement slot and/or a timing of the personalized advertisement slots.

4. The system of claim 2, wherein the personalized schedule includes targeted advertisement slots for a user group that includes the user.

5. The system of claim 4, wherein the personalization engine determines, based on user-group data, a total number of the targeted advertisement slots, a length of each targeted advertisement slot, and/or a timing of the targeted advertisement slots.

6. The system of claim 4, wherein:
the content recommendations include personalized content recommendations and/or targeted content recommendations, the targeted content recommendations for the user group, and
the personalized schedule includes one or more blocks of targeted content and/or one or more blocks of personalized content, the block(s) of targeted content including at least some of the targeted content recommendations, the block(s) of personalized content including at least some of the personalized content recommendations.

7. The system of claim 2, wherein:
the manifest manipulator is a channel manifest manipulator, and the system further comprises an advertisement manifest manipulator that is configured to insert personalized advertisements into the personalized advertisement slots.

8. The system of claim 2, wherein a content delivery network is configured to insert personalized advertisements into the personalized advertisement slots.

9. The system of claim 2, wherein the manifest manipulator is configured to insert personalized advertisements into the personalized advertisement slots.

10. The system of claim 1, wherein:
the content processor is configured to encrypt at least some of the respective pre-processed content assets using respective asset encryption keys to form encrypted pre-processed content assets, and
the system further comprises:
an encryption key management system configured to store the respective asset encryption keys; and
a re-encryption service configured to:
receive a request for a first encrypted pre-processed content asset, and
in response to the request, decrypt the first encrypted pre-processed content asset using a corresponding asset encryption key to form a first unencrypted pre-processed content asset and then re-encrypt the first unencrypted pre-processed content asset using a channel encryption key for the personalized media channel.

11. The system of claim 1, wherein the system further comprises a digital rights management (DRM) engine configured to pre-provision DRM licenses to a client application prior to and/or during a streaming of the personalized media channel, the DRM licenses for the media assets to be streamed in the personalized media channel.

12. A method for creating a personalized media channel, comprising:
in a content processor, pre-processing content assets to form respective pre-processed content assets and extracting content metadata from each media asset;
in a personalization engine, producing personalized content recommendations using personal user data of a target user and the content metadata;
in a scheduler, creating a personalized channel schedule for the personalized media channel, the personalized channel schedule including at least some of the personalized content recommendations;
in a manifest manipulator, creating a linear manifest according to the personalized channel schedule; and
producing a media stream for the personalized media channel according to the linear manifest.

13. The method of claim 12, further comprising:
receiving, in the personalization engine, real-time personal user data of the target user;
updating, with the personalization engine, the personalized content recommendations to include real-time personalized content recommendations;
creating, with the scheduler, an updated personalized channel schedule to include at least some of the real-time personalized content recommendations;
creating, with the manifest manipulator, an updated linear manifest according to the updated personalized channel schedule; and
producing the media stream according to the updated linear manifest.

14. The method of claim 13, wherein the real-time personal user data includes a rating of a streaming content asset that is currently streaming in the media stream.

15. The method of claim 12, further comprising:
producing, with the personalization engine, personalized advertisement slots using the personal user data; and
inserting, with the scheduler, the personalized advertisement slots in the personalized channel schedule.

16. The method of claim 15, wherein a total number of the personalized advertisement slots, a length of each personalized advertisement slot and/or a timing of the personalized advertisement slots is/are personalized using the personal user data.

17. The method of claim 12, wherein the personalized channel schedule is created using a template that includes one or more blocks of targeted content and/or one or more blocks of personalized content and/or one or more blocks of general-interest content.

18. The method of claim 12, further comprising:
encrypting, with the content processor, at least some of the respective pre-processed content assets using respective asset encryption keys to form encrypted pre-processed content assets;
storing the respective asset encryption keys in an encryption key management system;
in a re-encryption proxy:
receiving a request for a first encrypted pre-processed content asset to stream on the personalized media channel;
obtaining a corresponding asset encryption key for the first encrypted pre-processed content asset from the encryption key management system; and
in response to the request, decrypting the first encrypted pre-processed content asset using a corresponding asset encryption key to form a first unencrypted pre-processed content asset and then re-encrypting the first unencrypted pre-processed content asset using a channel encryption key for the personalized media channel.

19. The method of claim 12, further comprising pre-provisioning, with a digital rights management (DRM) engine, DRM licenses to a client application prior to and/or during a streaming of the personalized media channel, the DRM licenses for at least some of the media assets to be included in the media stream.
